(19) United States
(12) Patent Application Publication
(10) Pub. No.: US 2009/0134832 A1
(43) Pub. Date: May 28, 2009

(54) DYNAMO-ELECTRICAL MACHINE HAVING A TEMPERATURE DETECTION MEASUREMENT SYSTEM

(75) Inventor: AXEL KNAUFF, Munnerstadt (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/324,100

(22) Filed: Nov. 26, 2008

(30) Foreign Application Priority Data
Nov. 27, 2007 (EP) 07022965

(51) Int. Cl. H02H 3/04

(52) U.S. Cl. 318/490

(57) ABSTRACT

A dynamo-electrical machine includes a stator and a rotor co-rotating with a shaft. A rotor position transmitter is arranged on one end of the shaft, whereas contactless sensors are arranged stationarily facing the rotor. Data from the contactless sensors representing the surface temperature of the rotor together with position data from the rotor position transmitter are used to produce a position-specific temperature map of the rotor.

### CROSS-REFERENCES TO RELATED APPLICATIONS

This application claims the priority of European Patent Application, Serial No. 07022965, filed Nov. 27, 2007, pursuant to 35 U.S.C. 119(a)-(d), the content of which is incorporated herein by reference in its entirety as if fully set forth herein.

### BACKGROUND OF THE INVENTION

The present invention relates to a dynamo-electrical machine having a stator and a rotor, which is connected to a shaft such that they rotate together, with the temperature of the rotor being detected via sensors.

Nothing in the following discussion of the state of the art is to be construed as an admission of prior art.

In the case of dynamo-electrical machines which are being operated at their rating limit, the temperature of the rotating parts is an extremely critical parameter. The maximum permissible temperature governs the rating of the dynamo-electrical machine. In addition to reducing the output power, exceeding the maximum permissible temperature can also lead to destruction of the dynamo-electrical machine. For this reason, it is essential to monitor the temperature in dynamo-electrical machines which are subject to high utilization.

The rotating parts of a dynamo-electrical machine may be heated differently along the circumference on their axial extent. This relates to both asynchronous and synchronous dynamo-electrical machines.

Until now, in the case of dynamo-electrical machines which are subject to high utilization, the temperature has been detected by means of temperature sensors fitted into the end winding. This method has two major disadvantages; on the one hand the temperature of the rotating parts cannot be detected directly and on the other hand the temperature sensor has a certain mass which therefore has an associated thermal time constant which in turn means that the recorded measured value “lags behind” the actual temperature value of the winding.

In the extreme, for example in the case of highly dynamic operation of the dynamo-electrical machine, this leads to the rotating components being damaged by overheating. For this reason, the warning temperatures in the control systems for the dynamo-electrical machine are generally set 10% lower than necessary, which, of course, means that the dynamo-electrical machine cannot be used optimally up to its rating limit.

It would therefore be desirable and advantageous to provide an improved to dynamo-electrical machine obviate prior art shortcomings and to allow realization of a position-specific and accurate-temperature thermal map.

### SUMMARY OF THE INVENTION

According to one aspect of the present invention, a dynamo-electrical machine includes a stator, a rotor connected to a shaft and rotating with the shaft, a rotor position transmitter disposed at one end of the shaft, and contactless sensors arranged around the rotor and measuring a temperature of a surface of the rotor. The sensors produce in cooperation with the rotor position transmitter a position-specific temperature map of the rotor.

According to another aspect of the invention, a method for producing a position-dependent temperature map of a rotor of a dynamo-electrical machine includes the steps of measuring with a rotor position transmitter a position of the rotor, measuring with stationary contactless sensors a temperature on an end face of the rotor or along an axial direction of the rotor, transmitting the measured position of the rotor and the measured temperature to a processing unit, which produces the position temperature map of the rotor and, based on the position-specific temperature map, causes a controller to generate a control signal for driving a fan, outputting a message or initiating disconnection of the machine, or a combination thereof.

Since, according to the invention, the temperature of the rotor is now detected using a contactless sensor, and the position of the rotor is detected via the rotor position transmitter at the same time, the temperature of the rotor can be accurately and unambiguously determined at any time. The temperature of the rotating parts is proportional to the infrared radiation emitted by them, which is thus recorded without any delay by a sensor which provides contactless detection, in particular by an infrared sensor, and is transmitted to the processing unit.

According to another advantageous feature of the present invention, the contactless sensors may be arranged so as to face an end face of the rotor, or the sensors may be arranged on the stator, for example, on at least on one row of stator teeth extending in an axial direction and facing the air gap between the rotor and stator for measuring the axial temperature profile of the rotor. The sensors facing the end face of the rotor may be implemented as line sensors extending radially one below the other on the end face, for monitoring and detecting the temperature at different radial positions on the rotor.

Monitoring the temperature of the permanent magnets which are arranged in or on the rotor is important, because these permanent magnets could be demagnetized if the temperature becomes too high.

The machine may further include a processing unit which receives data from the contactless sensors and the rotor position transmitter. The processing unit produces the position-specific temperature map and generates, based on the position-specific temperature map, a control signal, for example, for driving a fan, outputting a message and/or initiating disconnection of the machine.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a partial longitudinal section through an electrical machine according to the present invention;

FIG. 2 shows a view of the stator,

FIG. 3 shows a view of the rotor,

FIG. 4 shows a side view of the rotor,

FIG. 5 shows an outline of the procedure, and

FIG. 6 shows a temperature profile.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

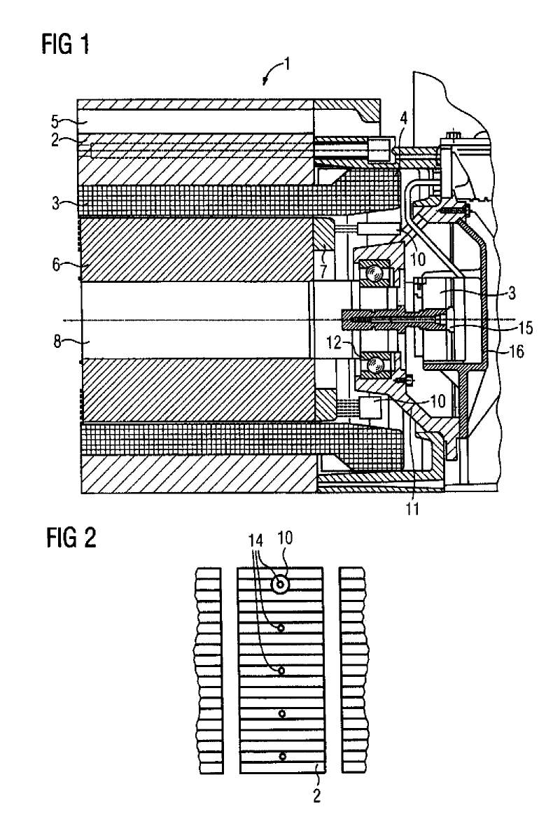

Turning now to the drawing, and in particular to FIG. 1, there is shown a partial longitudinal section of a dynamo-electrical machine, generally designated by reference numeral 1 and including a stator 2 which has a winding 3 in slots which are not illustrated in any greater detail. The winding 3 forms end windings 4 on the end faces of the stator 2. On the side facing away from the air gap, the stator 2 is provided, inter alia for cooling of the laminated core of the stator 2, with at least one cooling channel 5, which forms part of a cooling circuit. The coolant in the cooling circuit is in this case air or a liquid, in particular water.

A rotor 6 is connected to a shaft 8 such that they rotate together, for example by being shrunk on. In this exemplary embodiment, the rotor 6 is in the form of a squirrel-cage rotor of an asynchronous machine and therefore also has a short-circuiting ring 7 on the end face of the rotor 6.

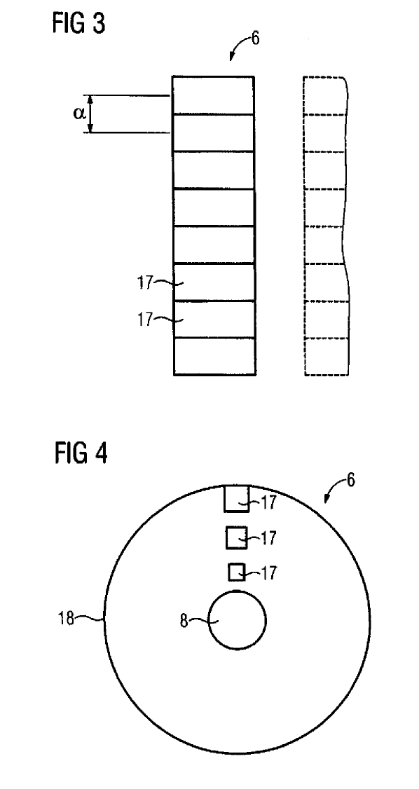

In other embodiments of the invention, as indicated in FIG. 3 and FIG. 4, the rotor may also be provided with permanent magnets, thus forming a synchronous machine with permanent-magnet excitation.

The invention is therefore suitable for any type of rotating motor.

A rotor position transmitter 9 is located on one end face of the shaft 8 and is connected, for example via an electrically non-conductive screw 15, to the shaft 8 such that they rotate together. The exact angular position and position of the rotor 6 are determined as an absolute value via this rotor position transmitter 9, in particular a resolver.

At least at this end, the shaft 8 is fixed by a bearing 12 which is held by an end frame 11. Temperature sensors 10 are now arranged in particular on the end frame 11 or in the area of the end frame 11 and detect, in particular in a contactless manner, the temperature on the end face of the rotor 6, irrespective of whether, in this case, this is a short-circuiting ring or, in another exemplary embodiment, the respective permanent magnets 17. In particular, these temperature sensors 10 are in the form of infrared sensors so that there is also no time delay between the instantaneous temperature and the detection of this temperature. These temperature values can therefore be passed on without any delay to a processing unit 13 and thus for evaluation.

Instead of a point infrared sensor, it is also possible to use a line sensor in order to detect areas of the rotors 6 which are located radially further inward, with this line sensor, as is illustrated in FIG. 4, detecting a predeterminable radial section of the rotor 6.

In order to also exactly detect the axial temperature profile of the rotor 6, in a further embodiment, the stator 2 is provided in the area of its air gap with a plurality of temperature sensors 10, which are arranged axially one behind the other, as shown in FIG. 2. The outline illustration shows the view from the stator bore of the laminated core of the stator 2.

These temperature sensors 10 detect the emitted infrared radiation and therefore the temperature on the surface of the rotor 6 where, for example, the permanent magnets are arranged under a binding 17, or a squirrel-cage is arranged in the slot in the rotor.

By way of example, FIG. 2 shows that every fourth laminate of the stator 2 has temperature sensors 10 on the side facing the air gap of the dynamo-electrical machine. In this case, for example, at least one laminate has a radially running channel on the outside or at least as far as the cooling channel, in order to connect the temperature sensor 10 to a processing unit.

Together with the information from the rotor position transmitter 9, it is now possible to detect with pinpoint accuracy the temperature of the rotor 6 both on the end face or end faces and along its axial profile.

FIG. 3 shows this, in particular by way of an outline detail of a rotor 6, which is provided with permanent magnets arranged axially one behind the other. In this case, the distance between the permanent magnets A is advantageously also the distance between the temperature sensors 10 on the stator 2 as shown in FIG. 2.

In order to detect a temperature even when the permanent magnets 17 are buried, line plotters are arranged opposite the end face of the rotor 6, detecting both the radially outer areas of the rotor 6, as well as those areas of the rotor 6 which are located radially further inward, in particular permanent magnets 17.

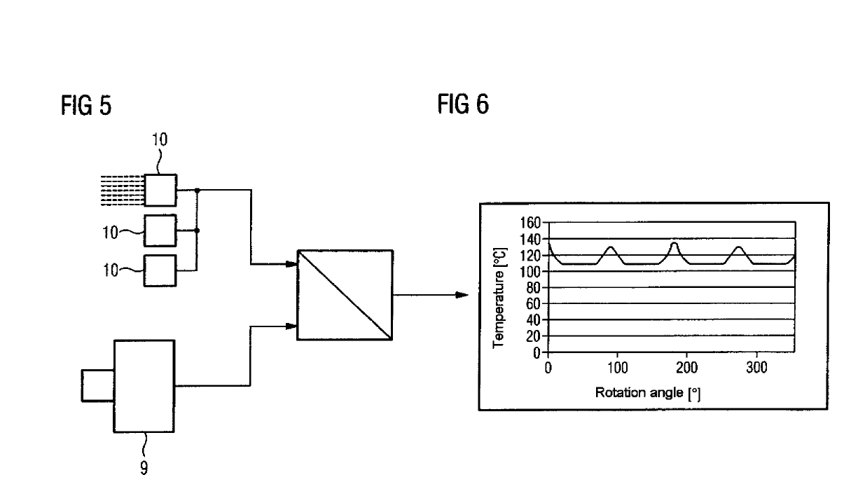

FIG. 5 shows an outline illustration of the information processing of the temperature detection on which the system according to the invention, in particular the dynamo-electrical machine, is based. The temperature of the rotor 6, or of components located on the rotor 6, such as permanent magnets 17 of the squirrel cage 7 are advantageously detected via the temperature sensors 10, in particular infrared sensors, on the end faces of the rotors 6 and/or over the axial profile of the stator 2. The data is transmitted individually or via a common data line, in particular a bus system, to a processing unit 13. The rotor position transmitter 9 also stores the respective rotation angle of the rotor 6 in this processing unit 13. It is therefore possible to define a temperature distribution, as shown in FIG. 6, at least on the end face or faces of the rotor 6, providing an accurate indication of the dependency on a rotation angle where temperature maxima of a possibly critical nature are present.

If the temperature sensors 10 are also distributed over the axial length of the stator 2, the information according to the previous exemplary embodiment need be determined not just with respect to the circumference and the rotation angle but at the same time also with respect of the axial position of the temperature sensor 10 over the axial length of the stator 2.

This would therefore result, based on FIG. 6, in a 3-D diagram which, in addition to the information relating to the temperature over the rotation angle and in a third dimension, indicates further temperature profiles as a function of the axial distance from an end face of the rotor 6.

In order to obtain a complete thermal map of the dynamo-electrical machine, temperature sensors can additionally also be provided, for example, on the stationary parts such as the end winding, laminated core of the stator 2, and bearing 12.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A dynamo-electrical machine comprising:
a stator,
a rotor connected to a shaft and rotating with the shaft,
a rotor position transmitter disposed at one end of the shaft, and
contactless sensors arranged around the rotor and measuring a temperature of a surface of the rotor, said sensors producing in cooperation with the rotor position transmitter a position-specific temperature map of the rotor.

2. The dynamo-electrical machine of claim 1, wherein the contactless sensors are arranged so as to face an end face of the rotor.

3. The dynamo-electrical machine of claim 1, wherein the contactless sensors are arranged on the stator.

4. The dynamo-electrical machine of claim 3, wherein the sensors are arranged on the stator on at least on one row of teeth extending in an axial direction and facing an air gap.

5. The dynamo-electrical machine of claim 2, wherein the sensors facing the end face of the rotor are formed as line sensors.

6. The dynamo-electrical machine of claim 1, wherein the contactless sensors comprise infrared sensors.

7. The dynamo-electrical machine of claim 1, further comprising a processing unit receiving data from the contactless sensors and the rotor position transmitter, said processing unit producing the position-specific temperature map and based on the position-specific temperature map generating a control signal for driving a fan, outputting a message or initiating disconnection of the machine, or a combination thereof.

8. A method for producing a position-specific temperature map of a rotor of a dynamo-electrical machine, comprising the steps of:
measuring with a rotor position transmitter a position of the rotor,
measuring with stationary contactless sensors a temperature on an end face of the rotor or along an axial direction of the rotor,
transmitting the measured position of the rotor and the measured temperature to a processing unit, which produces the position-specific temperature map of the rotor and, based on the position-specific temperature map, causes a controller to generate a control signal for driving a fan, outputting a message or initiating disconnection of the machine, or a combination thereof.
